(19) United States
(12) Patent Application Publication
(10) Pub. No.: US 2022/0386576 A1
(43) Pub. Date: Dec. 8, 2022

(54) ALL-WEATHER GLOWING BAIT

(71) Applicant: All Weather Bait LLC, New Berlin, WI (US)

(72) Inventors: Pranil Panda, New Berlin, WI (US); Debiprasad Panda, New Berlin, WI (US)

(21) Appl. No.: 17/805,113

(22) Filed: Jun. 2, 2022

Related U.S. Application Data
(60) Provisional application No. 63/195,825, filed on Jun. 2, 2021.

(51) Int. Cl. A01K 85/01

(52) U.S. Cl. CPC A01K 85/015

(57) ABSTRACT

An all-weather glowing bait is provided. The all-weather glowing bait can include a housing and one or more light-emitting diodes (LEDs). The one or more LEDs, either alone or in combination, can be configured to emit light of different colors and intensities. The all-weather glowing bait can also include a power source and a voltage controller coupled to the one or more LEDs. The color and/or intensity of the LEDs can be controlled via a manual switches on the all-weather glowing bait, or remotely through telecommunication.

### CROSS-REFERENCE TO RELATED APPLICATION

This application claims the benefit of the filing date of U.S. Provisional Application Ser. No. 63/195,825 filed Jun. 2, 2021, entitled, “All-Weather Glowing Bait”, which is hereby incorporated by reference as if fully set forth herein.

### BRIEF SUMMARY OF THE INVENTION

This disclosure generally relates to a bait. More particularly, the disclosure relates to a bait that include a plurality of light sources such that the bait can glow in various weather conditions. The bait can be controlled, either directly or remotely, to adjust its light intensity and/or colors projected by the light sources, thus better able to attract fish.

### BACKGROUND OF THE INVENTION

It is well known that glowing bait attracts fish. The fisherman/hobbyist uses glowing bait to catch more fish in a shorter time. A variety of glowing baits are available in the market which operate with a fixed color. The choice of bait color depends on the weather (sunny/cloudy), water color (green, blue, brown, murky, clear), depth of water, and species of fish. Since present bait color is fixed, each bait can be used only in certain weather and background condition. Consequently, fisherman/hobbyists are forced to carry varieties of baits with them and use them per the demand of the weather, water color, species of fish, etc. The need of varieties of bait makes it expensive and takes more space in the fisherman's/hobbyist's kit.

A need exists for bait that can be used in all weather, which can reduce the cost of fishing by negating the need to purchase multiple types of bait to use in different weather conditions, free up kit space, and reduce the amount of time fisherman/hobbyists spend changing baits.

### BRIEF DESCRIPTION OF THE DRAWINGS

FIG. 1 illustrates a system diagram of a bait according to an exemplary embodiment.

FIG. 2 illustrates a process diagram of selecting and generating a color for a bait according to an exemplary embodiment.

Before explaining the disclosed embodiment of the present invention in detail, it is to be understood that the invention is not limited in its application to the details of the particular arrangement shown, since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

While this invention is susceptible of embodiments in many different forms, there are shown in the drawings and will be described in detail herein specific embodiments with the understanding that the present disclosure is an exemplification of the principles of the invention. It is not intended to limit the invention to the specific illustrated embodiments. The features of the invention disclosed herein in the description, drawings, and claims can be significant, both individually and in any desired combinations, for the operation of the invention in its various embodiments. Features from one embodiment can be used in other embodiments of the invention.

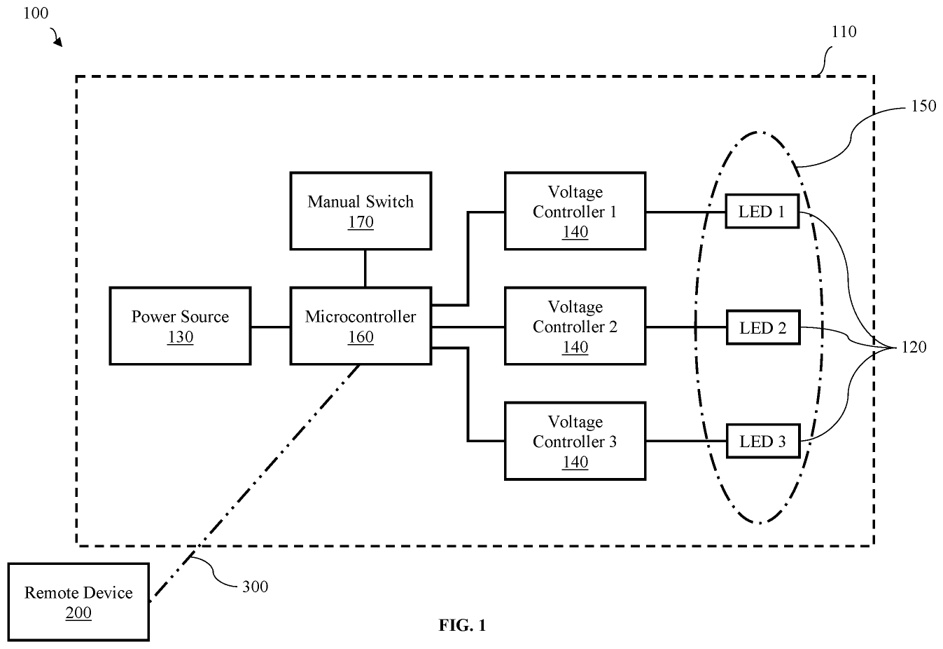

As shown in FIG. 1, the embodiments of this disclosure include a bait.

Lake fishing is very popular. Most lakes are not clear, due to phytoplankton, dissolved matter, and particles. In fertile waters, green is common, and reservoirs often show brown. In lakes with moderate plankton levels, blue and violet light are strongly absorbed while green and yellow wavelengths become dominant in deeper water. In muddy water, red wavelengths are transmitted deepest. For a fish to most easily detect an object, contrast between that object and the background is beneficial. Using the walleye as an example, a reddish or orange lure should be most easily seen against a greenish lake background or near vegetation. In a murky river water, contrasting hues of black and purple or blue should show best, while reds become harder to see. Presently, fisherman/hobbyists carry varieties of baits with them and use them depending on the weather, color and depth of water, and fish type. Hence, it is expensive and takes more space in the kit. Embodiments of an all-weather glowing bait can solve these problems by providing a bait whose color can be controlled. The all-weather glowing bait according to exemplary embodiments herein can be used for multiple species of fish and is suitable for all weather and for all water colors.

Referring to FIG. 1, according to an exemplary embodiment, an all-weather glowing bait 100 (“AWG Bait”) can include a housing 110 containing at least one light-emitting diode (LED) 120 configured to emit light in at least three colors.

In some embodiments, the AWG Bait 100 can contain three, or at least three, LEDs 120. In an embodiment, each LED 120 is configured to emit light having a prime color (red, green, blue, or yellow). In some embodiments, the AWG Bait 100 can include three LEDs 120, with the first LED 120 configured to emit a red light, the second LED 120 configured to emit a green light, and the third LED 120 configured to emit a blue light.

An intensity of each LED 120 (or prime color) can be controlled by controlling the voltage across or current through the LED 120 individually. The AWG Bait 100 color can be changed to any major color of interest by combining the three primary colors with varying intensity, and thus can be used for all fish and for all weather and water conditions.

The current offerings of baits are limited to particular species and conditions. Thus, fisherman/hobbyists must carry a variety of lures with them. It is expensive to purchase a variety of lures. Further, keeping a variety of lures in a kit takes up more space in a kit and increases the weight of the kit. Additionally, fisherman/hobbyists waste time changing lures while fishing as conditions change. The AWG Bait 100 solves these problems by being a single bait that is capable of glowing in a variety of colors. By controlling the color of the AWG Bait 100, it can be used as a lure in all water irrespective of weather (cloudy/sunny), water color (muddy, green, blue, clear, etc.), and species of fish.

In some embodiments, the AWG Bait 100 resembles the targeted fish's prey and glows attractively irrespective of weather.

In some embodiments, the AWG Bait 100 can include three LEDs 120, with the first LED 120 configured to emit a red light, the second LED 120 configured to emit a green light, and the third LED 120 configured to emit a blue light. Other colors can be produced by combining these three primary colors in appropriate ratios by controlling their intensities. The intensity of each LED 120 can be controlled by controlling the voltage across each LEDs 120. In such embodiments, the AWG Bait 100 can include three discrete LEDs 120 of red, blue, and green color

In another embodiment, the AWG Bait 100 can includes one or more RGB LEDs 120. A “RGB LED” is a single LED configured to emit red, green, and blue light at varying intensities. Nonlimiting examples of suitable RGB LEDs 120 include common anode LEDs, common cathode LEDs, and combinations thereof. In some instances, a RGB LED 120 can be used with the AWG Bait 100 when the AWG Bait 100 already has three LEDs 120 built-in. In some embodiments, the AWG Bait 100 has one RGB LED 120. In other embodiments, the AWG Bait 100 has more than one RGB LED 120. In further embodiments, the AWG Bait 100 has two RGB LEDs 120, or three RGB LEDs 120, or four RGB LED 120, or five RGB LED 120, or six RGB LEDs 120.

The AWG Bait 100 can be configured to emit more than three colors of visible light, with a single color visible at one time. In other words, when an individual views the AWG Bait 100 at a first moment in time, the colors of the LEDs 120 combine at a first intensity combination can form a first visible color; when viewed at a second moment in time, the colors of the LEDs 120 combine at a second intensity combination to form a second visible color; and so on. It is understood that the second intensity combination is different than the first intensity combination, and the second visible color is different than the first visible color.

In some embodiments, the AWG Bait 100 can include at least one, or at least two, or at least three, or at least four, or at least five, or at least six LEDs 120, with the proviso that the LEDs 120 are configured to emit light in at least three colors. Each LED 120 unit can be configured to emit light in at least three colors (e.g., a RGB LED), or each LED 120 unit can be configured to emit light in a single color, or a combination thereof.

In an embodiment, the AWG Bait 100 can include from 1 to 15, or from 1 to 12, or from 1 to 10, or from 1 to 8, or from 1 to 6, or from 1 to 4, or from 1 to 3, or from 2 to 15, or from 2 to 12, or from 2 to 10, or from 2 to 8, or from 2 to 6, or from 2 to 4, or from 3 to 15, or from 3 to 12, or from 3 to 9, or from 3 to 6 LEDs 120, with the proviso that the LEDs 120 can be configured to emit light in at least three colors.

In some embodiments, the AWG Bait 100 can include 1, or 2, or 3, or 4, or 6, or 8, or 9, or 10, or 12, or 15, or 20 LEDs 120, with the proviso that the LED(s) 120 can be configured to emit light in at least three colors.

In an embodiment, the AWG Bait 100 can includes three, and only three, LEDs 120, the first LED 120 configured to emit a red light, the second LED 120 configured to emit a green light, and the third LED 120 configured to emit a blue light.

In an embodiment, each LED 120 can be an RGB LED. In other words, the AWG Bait 100 can exclude LEDs that are configured to emit a single color light.

The AWG Bait 100 can include has the housing 110. The housing 110 can be rigid or flexible. In some embodiments, the housing 110 can waterproof. The housing 110 can have two opposing surfaces: an inner surface and an outer surface. The outer surface can be in fluid communication with the ambient environment. The housing 110 can have a shape. Nonlimiting examples of suitable shapes include sphere, cube, cylinder, prism, pyramid, cuboid, and combinations thereof. In some embodiments, the housing 110 has a shape of a fish's prey, such as the shape of a fish (e.g., a minnow), an amphibian (e.g., a frog), an invertebrate (e.g., a worm, an insect), a reptile (e.g., a lizard), a crustacean (e.g., a crawfish), or a combination thereof.

The housing 110 can be opaque, translucent, transparent, or a combination thereof. In some embodiments, the housing 110 can be translucent or transparent. In some embodiments, the outer surface of the housing 110 can have a pattern (e.g., scales), a texture (e.g., ridges), or a combination thereof. In some embodiments, adornments can be affixed to the outer surface of the housing 110 to attract fish. Nonlimiting examples of suitable adornments include feathers, reflective components (e.g., metal pieces), furs, threads, and combinations thereof).

In some embodiments, the housing 110 can be connected to a hook, such as a barbed hook. The housing 110 can be connected to one or more than one hook. The hook can be removably or permanently connected to the housing 110. In some embodiments, the housing 110 can be connected to the hook via fishing line. In other embodiments, the hook is affixed to the housing 110.

The one or more LEDs 120 can be positioned on the outer surface of the housing 110, inside the housing 110, or a combination thereof. In some embodiments, the LEDs 120 can be positioned inside the housing 110, the housing 110 can form a waterproof shell around the LEDs 120, and the LEDs 120 can be configured to emit visible light through the housing 110.

The one or more LEDs 120 can be electrically connected to a power source 130. A nonlimiting example of a suitable power source 130 is a battery. Nonlimiting examples of suitable batteries include single-use batteries and rechargeable batteries. In some embodiments, the battery is a rechargeable battery that can be wirelessly recharged, recharged via an electrical connection (e.g., through a recharging port extending through the housing), or a combination thereof. In another embodiment, the battery is a single-use battery. In some embodiments, the battery is positioned inside the housing, the housing forming a waterproof shell around the battery.

The AWG Bait 100 can also include a voltage controller 140. The voltage controller can be capable of varying the voltage across each LED 120, thereby varying the intensity of the light emitted from each LED 120. The voltage across the LED(s) 120 can be controlled in a number of ways.

### Method 1

A battery can be used for driving the LEDs 120. The batteries can be electrically connected to the LEDs 120 through a series potentiometer. The series potentiometer can set the series resistance as desired. The current through the circuit can be controlled by controlling the potentiometer resistance. In effect, the battery voltage is dropped across the potentiometer resistance and the effective voltage across the LED 120 is reduced. By cutting down the potentiometer fully, the resistance can be made zero and full brightness of the LED 120 can be achieved. Similarly, by introducing the maximum resistance of the potentiometer, the entire battery voltage can be dropped across the resistance and hence the corresponding LED 120 and its color can be turned off.

Each LED 120 can be controlled separately by the above method using three similar circuits. With that approach, the intensity of separate red, blue, and green LEDs 120 can be controlled independently to the desired value. By mixing these three lights with different intensities, other colors can be produced (e.g., yellow, orange, magenta, purple, violet, cyan, chartreuse, blue, red, green, etc.). A bulb 150 can be used to house all three LEDs 120 to combine the three lights and emit the mixed light.

### Method 2

In Method 2, a pulse width modulated electronic switch (such as MOSFET/Transistor, etc.) is used instead of the potentiometer described in Method 1. The switch can be connected in series with the battery and the LED 120. By controlling the pulse width, the duty ratio of the corresponding switch can be controlled. The duty ratio, in effect, controls the actual voltage across the LEDs 120. Hence, by having duty ratio as one (where the switch is ON all the time) the full battery voltage is applied across the LEDs 120 and the intensity of the LED 120 is at a maximum. On the other hand, by having the duty ratio as zero (where the switch is always OFF), the LED 120 is turned off. Any other duty ratio increases the intensity proportional to the duty ratio of the pulse width modulated gate signal to the switch.

Three separate pulse width modulation circuits can be used to control each LED 120 independently.

The pulse width modulation can be achieved either in software using a microcontroller 160 or can be implemented in analog circuit using comparator circuit.

The microcontroller 160 can be selected with or without wireless communications (such as Bluetooth, WiFi, etc.). With Wireless communication, the color of the AWG Bait 100 can be controlled while in use by choosing respective colors from a remote control 200 or a cell phone application. Each color represents certain ratio of red:green:blue intensity or duty ratio of the corresponding switches. The duty cycle of individual LEDs 120 can be transmitted to the microcontroller 160 through a wireless communication protocol 300 to control the duty cycle of individual switches connected in series with LEDs 120. A cell phone application processes the required color to produce the duty ratio of three LEDs 120 and transmits the color signal to the microcontroller 160 through the wireless communication protocol 300, such as Bluetooth. A separate remote controller can be used instead of cell phone if desired. In some embodiments, the remote control 200 can choose a color from color bank and the microcontroller 160 can derive a combination reference voltages for the LEDs 120 for the selected color. The reference voltages can be compared with sawtooth/triangle wave to generate duty cycles needed for the LEDs 120.

In some embodiments, the voltage controller 140 can be electrically connected to one or more manual switches 170. The manual switch can extend through the housing 110, or it can be formed (at least in part) by the housing 110. Nonlimiting examples of suitable switches include buttons, toggle switches, dials, and combinations thereof. In some embodiments, the manual switch 170 can be a button and the voltage can be controlled via depression of the button (e.g., to produce a green light with a first depression, a yellow light following a second depression, an orange light following a third depression, a red light following a fourth depression, a purple light following a fifth depression, a blue light following a sixth depression, a cyan light following a seventh depression, and the light is turned off after a eighth depression). In some embodiments, the button is formed in part by the housing 110. For example, the housing 110 can be formed at least in part by a flexible material that enables an individual to depress the housing to trigger the button switch.

In another embodiment, the manual switch 170 can be a dial and the voltage can be controlled by turning the dial.

In some embodiments, the voltage controller 140 can be configured to receive wireless signals (e.g., via Bluetooth, WiFi, etc.) from a wireless device (e.g., a remote control 200 or a cellular phone) to control whether the LEDs 120 are on or off, and the voltage across each LED 120.

Each LED 120 can be configured to emit light in a steady stream, or in a pattern (e.g., flashing or blinking), or a combination thereof.

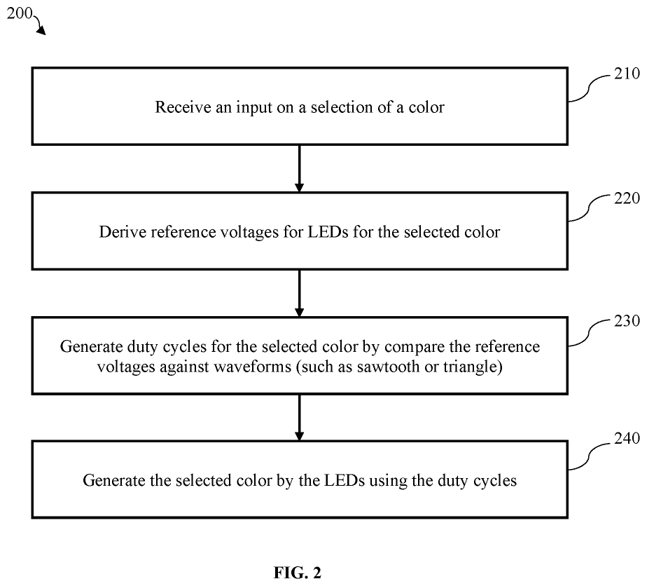

Referring to FIG. 2, a process 200 of selecting and generating a color is illustrated. At Step 210, an input on a selection of color can be received by the microcontroller 160. The color selection can be done in several different ways. By way of example, a user can press the manual switch 170 to cycle through and select one of available colors. Alternatively, the remote control 200 (such as an application running on a cell phone or a dedicated remote device) can provide a color bank to the user to select a color. In either case, the user's selection can be received by the microcontroller 160 through wired connection or through wireless communication.

At Step 220, the microcontroller 160 can derive references voltages for LEDs 120 for the selected color.

At Step 230, duty cycles can be generated for the LEDs 120 for the selected color. This can be done in a plurality of methods. For example, one or more comparators can be used to compare the reference voltages against sawtooth or triangle waveforms to generate the appropriate duty cycles.

At Step 240, the LEDs 120 can generate the selected color by used the duty cycles generated at the previous step which severs to control the actual voltage across the LEDs 120. Thus completing the color selection and generation process 200.

### Embodiments

In an embodiment, the AWG Bait 100 can include the housing 110 and at least one LED 120. The LED 120 can be configured to emit red, green, and blue light at varying intensities.

In some embodiments, the AWG Bait 100 can include a first LED 120 configured to emit red light, a second LED 120 configured to emit green light, and a third LED 120 configured to emit blue light. In alternate embodiments, the AWG Bait 100 can one or more RGB LEDs 120.

In some embodiments, the at least one LED 120 can be positioned inside the housing 110. The at least one LED 120 can be electrically connected to a power source 130 and a voltage controller 140. The housing 110 can form a waterproof shell around the at least one LED 120, the power source 130, and the voltage controller 140.

In some embodiments, the voltage controller 140 can be electrically connected to a manual switch 170 extending through the housing.

In some embodiments, the voltage controller 140 can be configured to receive wireless signals from a wireless device.

In some embodiments, the AWG Bait 100 can be configured to emit more than three colors of visible light, with a single color visible at one time.

In some embodiments, a method of attracting fish in all weather conditions with a single bait is provided, the method including (i) providing an AWG Bait with (a) a housing, (b) at least one LED, the at least one LED configured to emit red, green, and blue light at varying intensities, and (c) a voltage controller; (ii) controlling the voltage of the at least one LED to vary the intensity of the red, green, and blue light to achieve a first pre-determined visible light color; and (iii) controlling the voltage of the at least one LED to vary the intensity of the red, green, and blue light to achieve a second pre-determined visible light color.

### Definitions

For purposes of United States patent practice, the contents of any referenced patent, patent application or publication are incorporated by reference in their entirety (or its equivalent US version is so incorporated by reference) especially with respect to the disclosure of definitions (to the extent not inconsistent with any definitions specifically provided in this disclosure) and general knowledge in the art.

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1-7 above includes subranges 1 to 2; 2 to 6; 5 to 7; 3 to 7; 5 to 6; etc.).

The terms “comprising,” “including,” “having,” and their derivatives, are not intended to exclude the presence of any additional component, step or procedure, whether or not the same is specifically disclosed. In order to avoid any doubt, all methods claimed through use of the term “comprising” may include any additional steps, parameters, procedures, or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually, as well as in any combination. Use of the singular includes use of the plural and vice versa.

It is specifically intended that the present disclosure not be limited to the embodiments and illustrations contained herein, but include modified forms of those embodiments including portions of the embodiments and combinations of elements of different embodiments as come within the scope of the claims.

Specific embodiments of an all-weather glowing bait according to the present invention have been described for the purpose of illustrating the manner in which the invention can be made and used. It should be understood that the implementation of other variations and modifications of this invention and its different aspects will be apparent to one skilled in the art, and that this invention is not limited by the specific embodiments described. Features described in one embodiment can be implemented in other embodiments. The subject disclosure is understood to encompass the present invention and any and all modifications, variations, or equivalents that fall within the spirit and scope of the basic underlying principles disclosed and claimed herein.

What is claimed is:

1. An all-weather glowing bait comprising:
a first light-emitting diode (LED) coupled to a first voltage controller and a power source; and
a housing for containing the first LED, the first voltage controller, and the power source;
wherein the first voltage controller is configured to control at least one of a color and an intensity of a light emitted by the first LED.

2. The all-weather glowing bait of claim 1, wherein the first voltage controller is a potentiometer.

3. The all-weather glowing bait of claim 1, wherein the first voltage controller is a pulse width modulated electronic switch.

4. The all-weather glowing bait of claim 1, wherein the first voltage controller comprising a comparator coupled to a pulse width modulated electronic switch.

5. The all-weather glowing bait of claim 1, wherein the first LED is a red, blue, and green LED (RGB LED).

6. The all-weather glowing bait of claim 1 further comprising:
a second LED coupled to a second voltage controller and the power source; and
a third LED coupled to a third voltage controller and the power source,
wherein the first LED is configured to emit a red light, the second LED is configured a green light, and the third LED is configured to emit a blue light.

7. The all-weather glowing bait of claim 1 further comprising:
a microcontroller coupled to the first voltage controller, wherein the microcontroller is configured to control the first LED to emit a first pre-determined visible light color and a second pre-determined visible light color.

8. The all-weather glowing bait of claim 7, wherein the microcontroller is configured to receive wireless communication to control the first LED.

9. The all-weather glowing bait of claim 7 further comprising:
a manual switch coupled to the microcontroller, wherein the microcontroller is configured to control the first LED to emit the first pre-determined visible light color and the second pre-determined visible light color depending on an input received by the manual switch.

10. The all-weather glowing bait of claim 1 further comprising a bulb to house the first LED.

11. An all-weather glowing bait comprising:
a first light-emitting diode (LED) coupled to a first voltage controller, a microcontroller, and a power source;
a second LED coupled to a second voltage controller, the microcontroller, and the power source;
a third LED coupled to a third voltage controller, the microcontroller, and the power source; and
a housing for containing the first LED, the second LED, the third LED, the first voltage controller, the second voltage controller, the third voltage controller, the microcontroller and the power source,
wherein microcontroller is configured to control the first LED, the second LED, and the third LED such that the all-weather glowing bait can emit lights of different colors and intensities.

12. The all-weather glowing bait of claim 11, wherein the microcontroller is further configured to receive wireless communication to control the all-weather glowing bait.
